(19) United States
(12) Patent Application Publication
(10) Pub. No.: US 2024/0231904 A1
(43) Pub. Date: Jul. 11, 2024

(54) SCHEDULING DEVICE, SCHEDULING METHOD, AND SCHEDULING PROGRAM

(71) Applicant: Nippon Telegraph and Telephone Corporation, Tokyo (JP)

(72) Inventors: Tetsuro NAKAMURA, Musashino-shi, Tokyo (JP); Kei FUJIMOTO, Musashino-shi, Tokyo (JP); Shogo SAITO, Musashino-shi, Tokyo (JP)

(21) Appl. No.: 18/279,607

(22) PCT Filed: Mar. 5, 2021
(86) PCT No.: PCT/JP2021/008680

§ 371 Date: Sep. 1, 2023

(51) Int. Cl. G06F 9/48

(52) U.S. Cl. CPC G06F 9/4887

(57) ABSTRACT

A scheduling device includes a controller unit that acquires a model used by each task, an FPGA control unit that performs control to switch a setting of the FPGA in such a manner that the model acquired by the controller unit becomes processable, and a scheduler unit that refers to a queue that stores a task for each model used by each task, reads a task using a model that has become processable by switching by the FPGA control unit, and causes the FPGA to execute the task.

### TECHNICAL FIELD

The present invention relates to a scheduling device, a scheduling method, and a scheduling program.

### BACKGROUND ART

Performance to be obtained varies depending on resource allocation of how much resources, which are computer resources of hardware, are allocated to a virtual machine (VM) or a container of software. Accordingly, a function called “autoscale” that automatically increases or decreases the number of VMs/containers according to a server load of the resources has been proposed.

Patent Literature 1 describes a network performance guarantee system that performs resource allocation such that unnecessary resources are reduced in a VM/container by executing the autoscale with a small resource allocation amount.

Patent Literature 2 describes an autoscale type performance guarantee system that obtains whether or not there is dependency of an allocation amount of resources with respect to performance, and can increase or decrease only resources of the allocation amount corresponding to the dependency by autoscale execution.

### CITATION LIST

### Patent Literature

Patent Literature 1: JP 2020-123848 A
Patent Literature 2: JP 2020-123849 A

### SUMMARY OF INVENTION

### Technical Problem

Hardware accelerators that perform a part of processing performed by a central processing unit (CPU) on behalf of the CPU to speed up the processing have been widely used. The accelerator is implemented as, for example, a field programmable gate array (FPGA, rewritable logic circuit). The FPGA device operates, for example, a model in which a convolutional neural network (CNN) algorithm is implemented at a higher speed than the CPU.

Note that the CNN is one of artificial intelligences (neural networks) mainly used for image recognition/classification, and has a convolution layer that extracts local features of an image. As the CNN algorithm, for example, various CNN algorithms in which the depth and size of each layer are different according to use cases such as a model suitable for image classification and a model suitable for face recognition have been proposed.

In a case where plenty of FPGA resources can be used, a dedicated FPGA device is only required to be prepared for each model. Then, it is only required to apply autoscale as in Patent Literatures 1 and 2 between users who use the same model.

On the other hand, in a case where the FPGA resources are small in order to reduce initial investment (capital expenditure (CAPEX)) or the like, it is necessary to temporally switch between a plurality of types of models sharing the same FPGA resources. Note that, as a cause of the small FPGA resources, it is also conceivable that each member jointly uses an on-premise FPGA in a research laboratory of a university or the like.

Here, the scheduler of the CPU that is used in Linux (registered trademark) and is frequently studied is not suitable for use of switching of the model on the FPGA resource. First, a task selection function implemented in the scheduler of the CPU executes scheduling of the CPU by time slicing on the premise of a context switch. However, context is not stored in the FPGA, and thus conventional scheduling of Linux using time slices cannot be applied.

As described above, in the related art, no function is provided for supporting switching control of the model on the FPGA on a platform. That is, there has not been provided any means for smoothly switching a model executed by each of multiple users on the shared FPGA.

Accordingly, a main object of the present invention is to execute tasks of a plurality of users while switching a plurality of types of models on the same accelerator.

### Solution to Problem

In order to solve the above problem, a scheduling device of the present invention has the following characteristics.

The present invention includes:
a controller unit that acquires a model used by each task;
a control unit that performs control to switch a setting of an accelerator in such a manner that the model acquired by the controller unit becomes processable; and
a scheduler unit that refers to a queue that stores a task for each model used by each task, reads a task using a model that has become processable by switching by the control unit, and causes the accelerator to execute the task.

### Advantageous Effects of Invention

According to the present invention, tasks of a plurality of users can be executed while switching a plurality of types of models on the same accelerator.

### BRIEF DESCRIPTION OF DRAWINGS

FIG. 1 is a configuration diagram of a scheduling device according to the present embodiment.

FIG. 2 is a configuration diagram illustrating details of the scheduling device according to the present embodiment.

FIG. 3 is a hardware configuration diagram of the scheduling device according to the present embodiment.

FIG. 4 is a table illustrating classification by combination of task requirements according to the present embodiment.

FIG. 5 is a flowchart illustrating deadline type scheduling processing according to the present embodiment.

FIG. 6 is a flowchart illustrating best effort type scheduling processing according to the present embodiment.

FIG. 7 is a flowchart illustrating mixed type scheduling processing according to the present embodiment.

### DESCRIPTION OF EMBODIMENTS

Hereinafter, one embodiment of the present invention will be described in detail with reference to the drawings.

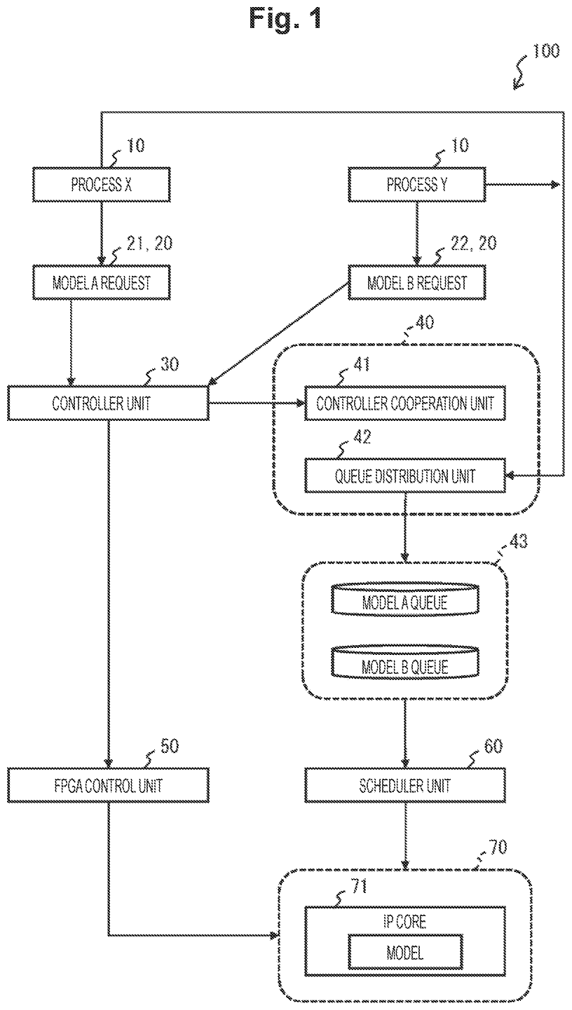

FIG. 1 is a configuration diagram of a scheduling device 100.

The scheduling device 100 includes a CPU (not illustrated) which is an execution environment of the process 10 and an FPGA 70 which is an execution environment of the model. Note that each of the execution environment of the process 10 and the execution environment of the model may be configured as devices different from the scheduling device 100.

The process 10 is a processing unit of a result of deploying the program by the user himself/herself. In the example of FIG. 1, a process 10 (first user process 10X and second user process 10Y) of each of two users is deployed.

One process 10 performs one or more “tasks”. A task is also called a job, and is a processing unit that performs individual processing such as image classification and face recognition. One task executes inference processing using a certain “model”. Thus, a processing request in which each task uses each model is stored in the queue 43.

Note that one process 10 may execute a plurality of tasks in parallel. Even in the same process 10, a plurality of tasks using different CNN algorithm models may be combined and processed in a pipeline manner in a face recognition use case and the like.

An IP core 71 in the FPGA 70 is a hardware accelerator that executes a plurality of types of models while switching the models. The IP core 71 is, for example, an inference circuit that implements convolution calculation of CNN. Once the circuit is configured in the IP core 71, various CNN models can be switched and used without reconfiguring the circuit. However, in order to switch a plurality of types of models executed by the IP core 71, a switching time occurs.

Here, there are appropriate models for each use case such as image classification, face authentication, person (pose) detection, object detection, and sign/lane detection. For example, a task of the image classification uses a model called Resnet50 to infer whether the input image is a cat image or a dog image. Furthermore, even in the same CNN algorithm, if the learning method is different, the CNN algorithm may be used as separate CNN models.

Note that premises of processing of switching models in the IP core 71 is as follows.

(Premise 1) The FPGA 70 starts a task using a model in response to a notification from the CPU, and performs a lookaside type process of returning the processing to the CPU at the end of the task.

(Premise 2) Before each task is executed by the FPGA 70, in a case where the model used by the task is not set in the IP core 71, a certain time of resetting time is required (corresponding to switching of the CNN models).

(Premise 3) After the IP core 71 is switched to a model A, a plurality of tasks using the model A can be continuously processed without the need to switch the IP core 71 until another task using another model B is executed.

(Premise 4) It is assumed that the switching time of the IP core 71 and the execution time of actual processing using the model are constant and can be acquired on the platform side (FPGA control unit 50 to be described later). However, each model execution request from each process 10 is aperiodic and unpredictable.

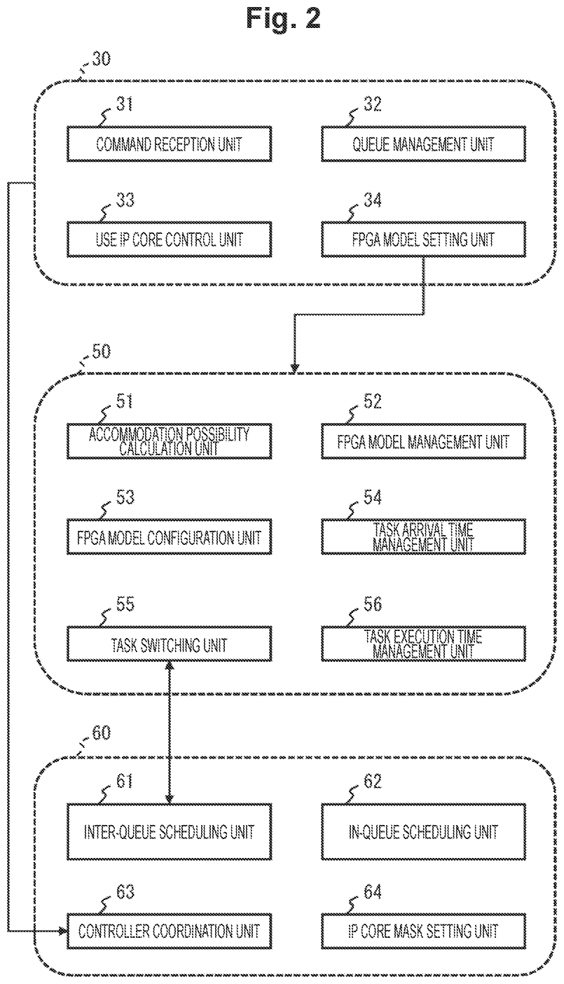

The scheduling device 100 includes a controller unit 30, a common unit 40, a queue 43, an FPGA control unit 50, and a scheduler unit 60 as a control unit that switches a model on the IP core 71. Details of the controller unit 30, the FPGA control unit 50, and the scheduler unit 60 will be described later with reference to FIG. 2.

Each process 10 notifies the controller unit 30 of a model A request 21, which is an execution request of a task using the model A, and a model B request 22, which is an execution request of a task using the model B, as model requests 20.

The common unit 40 includes a controller cooperation unit 41 and a queue distribution unit 42. The controller cooperation unit 41 receives information regarding the available queues 43 from the controller unit 30, and creates the queues 43 for each model. Then, the queue distribution unit 42 receives each task designated by the model request 20 from each process 10, and stores each task in the queue 43 for each model to be used.

Note that, in the model request 20, in addition to specification of a model type (models A, B, . . . ) indicating which model should be executed, a requirement (task requirement) regarding execution performance of the model may be specified from the process 10. The following two task requirements are representative, for example.
A Turn Around Time (TAT) requirement is an allowable maximum value (time limit) of the time (TAT) required from the arrival time of the task to the end time of the task, and 500 [ms] or the like is specified.
A Throughput (TP) requirement is an allowable minimum value of an amount processed per unit time (for example, one second), and 200 [batch/second] or the like is specified.

Hereinafter, various parameters related to the task requirement will be defined. “t” indicates a time (a certain moment), and “T” indicates a time (period length from start time to end time).

t_now is the current time.

t_arrival is the arrival time of the task.

T_tat[A] is a TAT requirement of the model A used by the task.

t_limit is the deadline time of the task.

Therefore, t_limit=t_arrival+T_tat[A].

T_wait is a waiting time until the task is started on the IP core 71.

t_start is the start time of the task.

Therefore, t_start=t_arrival+T_wait.

t_end is the end time of the task.

T_reconf[A-B] is a switching time of the FPGA from the model A to the model B.
T_exec[B] is an execution time of the task of the model B.

Therefore, when switching is necessary, t_end=t_start+T_reconf[A-B]+T_exec[B].

R[A] is a TP requirement of the model A.

P_total is a sum of the numbers of processes 10 handled by the CPU of the scheduling device 100.

FIG. 2 is a configuration diagram illustrating details of the scheduling device 100.

The controller unit 30 includes a command reception unit 31, a queue management unit 32, a use IP core control unit 33, and an FPGA model setting unit 34.

The command reception unit 31 receives a resource control command (the number of used IP cores) from the process 10.

Every time a task that uses a new model starts up, the queue management unit 32 notifies the controller cooperation unit 41 of creation of a queue 43 for the model (a set of queues having a plurality of priorities).

The use IP core control unit 33 manages an occupied/vacant state of the IP core 71 of the FPGA 70 and secures the number of IP cores designated by the command reception unit 31. In addition, the use IP core control unit 33 creates and manages a map fixedly allocated so as to be exclusive for each model as necessary. Further, the use IP core control unit 33 notifies the scheduler unit 60 of the allocation information every time the allocation information is updated, and returns NG when the number of vacant IP cores 71 is insufficient.

As described above, since the used IP core control unit 33 designates an IP core mask inside by checking at a vacant state of the IP core and sets the IP core mask in the scheduler unit 60, the information inside the cloud is not exposed to the process 10. Furthermore, the controller unit 30 is provided with an external IF to thereby implement dynamic control of resources.

The FPGA model setting unit 34 acquires a model used by each task from each process 10.

The FPGA control unit 50 includes an accommodation possibility calculation unit 51, an FPGA model management unit 52, an FPGA model configuration unit 53, a task arrival time management unit 54, a task switching unit 55, and a task execution time management unit 56.

The accommodation possibility calculation unit 51 determines whether or not each process 10 can be deployed on the basis of the task requirement of each process 10.

The FPGA model management unit 52 holds the model acquired by the FPGA model setting unit 34 as context data in association with the process 10.

The FPGA model configuration unit 53 actually switches the model of the IP core 71 with reference to the data held by the FPGA model management unit 52.

Note that, when scheduling is performed without considering a use model of the task, the throughput is significantly reduced. Therefore, it is desirable to determine the model switching timing so as to satisfy the TAT requirement requested by the process 10, for example, for the reasons and the like listed below.
When a task is executed by simple scheduling such as First In First Out (FIFO) and Round Robin (RR), the switching cost increases and the throughput decreases.
It is necessary to collectively process tasks to some extent after switching, but in a method of switching in a certain period of time, an idle state is generated and resource efficiency is low.
When the processing limit is determined and there is no task in the queue, the resource efficiency is increased by switching immediately, but a task having a small task arrival frequency is made to wait more than necessary, which affects the TAT requirement.

Therefore, by using the task arrival time management unit 54, the task switching unit 55, and the task execution time management unit 56, the FPGA control unit 50 determines the model switching timing so as to satisfy the TAT requirement.

First, the task arrival time management unit 54 monitors the queue 43 to acquire the arrival time of each task and holds the arrival time in the scheduling device 100. On the other hand, the task execution time management unit 56 monitors the FPGA 70 to acquire the execution time and the switching time of each task.

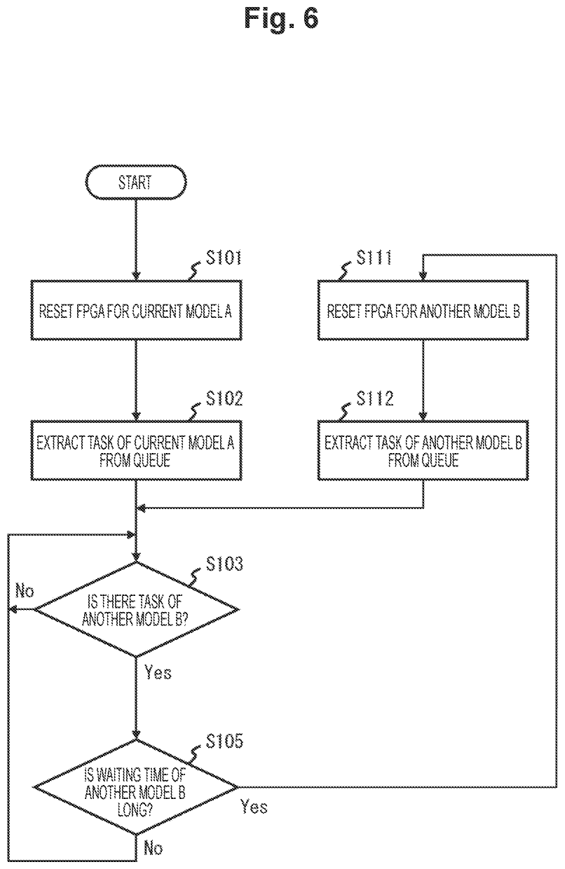

The task switching unit 55 performs control to switch the setting of the FPGA 70 in such a manner that the model acquired by the controller unit 30 becomes processable. That is, the task switching unit 55 determines the model switching timing so as to comply with the TAT requirement on the basis of various pieces of time information and time point information related to the task acquired by the task arrival time management unit 54 and the task switching unit 55. In this determination algorithm, fairness and waiting time of a task are considered (details are illustrated in FIG. 6).

In addition, in order to comply with the TP requirements, the accommodation possibility calculation unit 51 may acquire the TP requirements requested by each process 10 from the FPGA model setting unit 34 and determine whether or not deployment is possible.

The scheduler unit 60 includes an inter-queue scheduling unit 61, an in-queue scheduling unit 62, a controller cooperation unit 63, and an IP core mask setting unit 64.

The inter-queue scheduling unit 61 selects the queue 43 that is the task extraction source from the queues 43 for each independent model including the queue of each priority by a fair algorithm such as round robin.

The in-queue scheduling unit 62 selects a task to be executed in the queue 43 selected by the inter-queue scheduling unit 61 by an algorithm considering the priority, such as extracting a task from a queue having a high priority.

The controller cooperation unit 63 receives setting information (IP core mask) of the FPGA 70 from the controller unit 30.

The IP core mask setting unit 64 causes the FPGA 70 to execute the task acquired by the in-queue scheduling unit 62 with reference to the queue 43. Thus, the IP core mask setting unit 64 sets an IP core mask for each task received via the controller cooperation unit 63, and performs control so as not to use the IP core 71 that is not designated. Isolation (separation) of each process 10 is achieved by the IP core mask setting unit 64.

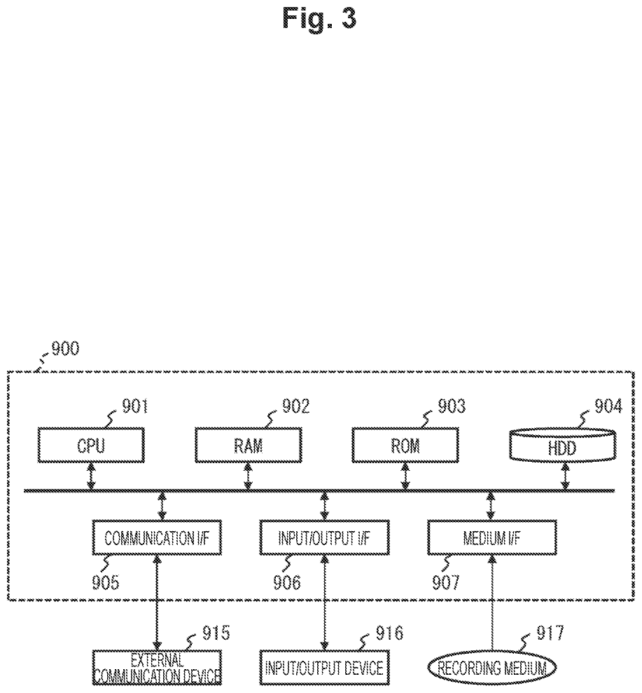

FIG. 3 is a hardware configuration diagram of the scheduling device 100.

The scheduling device 100 is configured as a computer 900 including a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads and writes data from and to a recording medium 917. Moreover, the CPU 901 controls each processing unit by executing a program (also referred to as an application or an app for abbreviation thereof) read into the RAM 902. Then, the program can be distributed via a communication line or recorded in a recording medium 917 such as a CD-ROM and distributed.

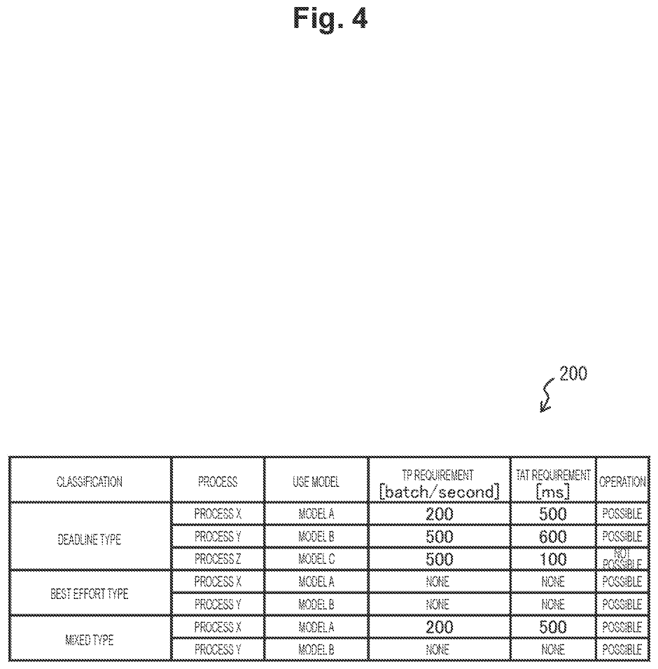

FIG. 4 is a table 200 illustrating classifications according to combinations of task requirements.

The table 200 associates, for each classification, a process 10, a use model of a task generated by the process 10, a task requirement (TAT requirement and TP requirement) specified by the model request 20 of the task, and availability of operation (deployment) of the process 10.
The classification “deadline type” is a case where a task requirement such as a TAT requirement (deadline time obtained from an arrival time of a task and a TAT) is strictly specified for each of all tasks.
The classification “best effort” is a case where a task requirement is not specified for any task.
The classification “mixed type” is a case where task requirements are specified for some tasks and no task requirements are specified for the other tasks.

Note that it is assumed that the task requirement of a process Z (model C) is newly imposed while maintaining the task requirement of a deployed process X (model A) and the task requirement of a deployed process Y (model B).

However, the processing capability of the FPGA 70 is insufficient to additionally comply with the task requirements of the model C. In this case, the accommodation possibility calculation unit 51 determines that the process Z is “deployment impossible” to prevent the excess processing.

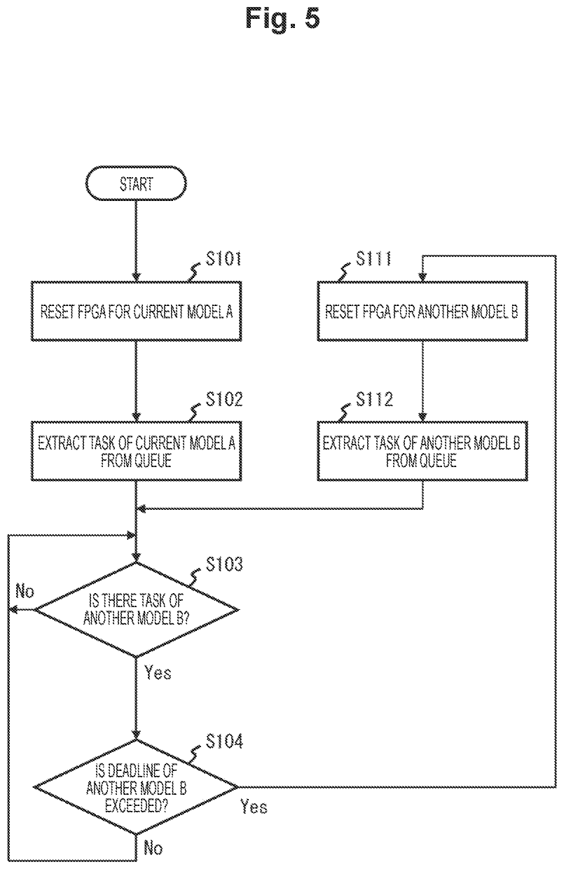

FIG. 5 is a flowchart illustrating deadline type scheduling processing. Before executing this flowchart, the command reception unit 31 receives the model request 20 (use Model, TAT Requirement, TP Requirement) from each process 10.

The FPGA model configuration unit 53 resets (or initially sets) the FPGA 70 for the current model A (S101).

The in-queue scheduling unit 62 extracts the task of the current model A from the queue 43 (S102), and causes the FPGA 70 to execute the task via the IP core mask setting unit 64.

The in-queue scheduling unit 62 determines whether or not a task of a model B different from the current model A exists in the queue 43 (S103). If No in S103, the in-queue scheduling unit 62 continues monitoring the queue 43 until the task of another model B exists.

When the task of another model B exists (S103, Yes), the task switching unit 55 assumes that the current model A operating in the FPGA 70 is switched to another model B, and determines that switching is necessary when the end time t_end of the another model B exceeds the deadline time t_limit of the another model B (S104, Yes). The determination expression in S104 is, for example, the following (Expression 1), and buf is an appropriate buffer time.

$$t\_now - t\_arrival > T\_tat [ B ] = ( T\_reconf [ A \to B ] + T\_exec [ B ] ) + buf \qquad ( Expression 1 )$$

For example, when t_now=12:20, t_arrival=12:18, T_tat [B]=0:30, T_reconf[A—B]=0:10, T_exec[B]=0:05, and buf=0:05,

Left side of (Expression 1)=12:20−12:18=0:02

Right side of (Expression 1)=0:30−(0:10+0:05)+0:05=0:20

Thus, since the left side is smaller than the right side, the determination expression is not satisfied (S104, No), and the switching at the current time 12:20 becomes unnecessary.

When switching is necessary (S104, Yes), the FPGA model configuration unit 53 resets the FPGA 70 from the current model A to another model B (S111). The in-queue scheduling unit 62 extracts the task of another model B from the queue 43 (S112) and causes the FPGA 70 to execute the task via the IP core mask setting unit 64.

Thereafter, the different model B reset in S111 is replaced with “current model A”, and the task switching unit 55 repeats the processing in and after S103.

FIG. 6 is a flowchart illustrating best effort type scheduling processing.

The flowchart of FIG. 6 is obtained by replacing S104 of FIG. 5 with S105. Before executing the flowchart of FIG. 6, the command reception unit 31 receives the model request 20 (use model is specified but task requirement is not specified) from each process 10.

The task switching unit 55 determines whether or not there are more tasks having a longer waiting time in the queue 43 of another model B than in the queue 43 of the current model A (S105). If Yes in S105, the processing proceeds to S111, and if No, the processing returns to S103.

Note that, in order to improve the overall throughput, a plurality of tasks using the same model should be continuously used, but in that case, the processing is concentrated on a model in which task requests are frequent.

Thus, in S105, the task switching unit 55 performs scheduling processing of switching the setting of the FPGA 70 in consideration of the following two guidelines.

(Guideline 1) The number of times of switching of the FPGA 70 is reduced by causing the FPGA 70 to continuously execute a plurality of tasks using the same model.

(Guideline 2) The setting of the FPGA 70 is switched to a model with many standby tasks in such a manner that the waiting time of the task stored in the queue 43 is shortened.

Specifically, in S105, the task switching unit 55 simultaneously considers not only the number of tasks but also a value aged by the waiting time of each task. The determination expression in $105 is, for example, the following (Expression 2).

$$W\_total [ A ] + S\_cost [ B ] < W\_total [ B ] \qquad ( Expression 2 )$$

W_total[B] is the total waiting time of all the standby tasks of the model B.

S_cost[B] is a switching cost to the model B, and is an adjustment factor for not switching the model frequently.

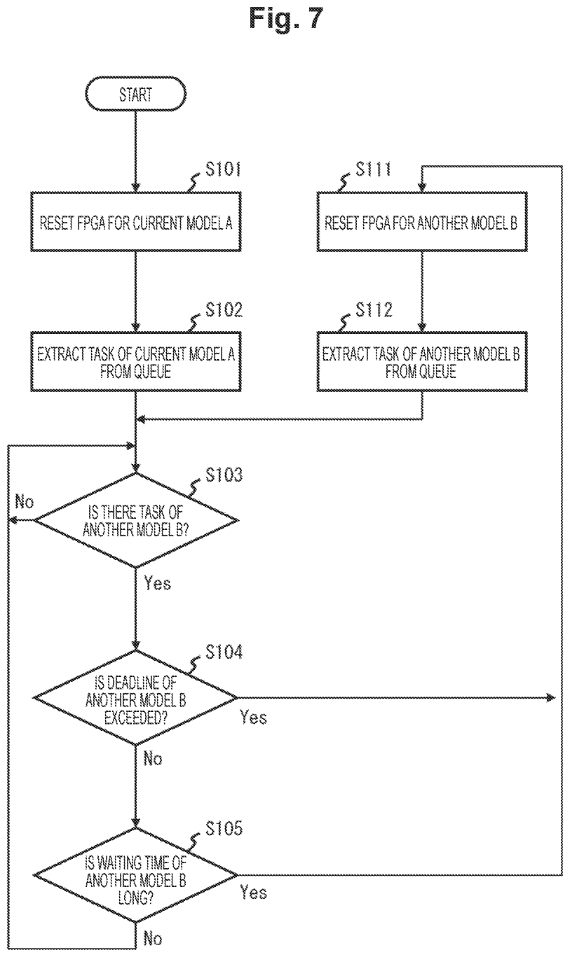

FIG. 7 is a flowchart illustrating mixed type scheduling processing.

The flowchart of FIG. 7 executes S104 of FIGS. 5 and S105 of FIG. 6 in order. That is, the condition for switching (resetting) to another model B may satisfy S104 or S105.

Note that, although the TAT requirement “T_tat[B]” is present on the right side of (Expression 1) determined in S104, there are also tasks for which the TAT requirement is not specified. In that case, by substituting sufficiently large T_tat[B] (=100 years or the like) as the provisional TAT requirement, it is possible to always fail to satisfy the determination expression of (Expression 1).

The scheduling processing (the processing of determining switching to the task B) for satisfying the TAT requirement has been described above with reference to FIGS. 5 to 7. Hereinafter, deployment determination processing of the process 10 by the accommodation possibility calculation unit 51 for satisfying the TP requirement will be described.

In consideration of the processes X and Y being executed, when the TP requirement of the process 2 to be newly deployed is severe and the TP requirements of the processes X, Y, and Z cannot be satisfied even if the process Z is deployed, the accommodation possibility calculation unit 51 determines that the deployment is impossible (capacity is exceeded) before deploying the process Z.

Thus, the accommodation possibility calculation unit 51 acquires the TP requirement requested by each process 10 from the FPGA model setting unit 34.

Then, the accommodation possibility calculation unit 51 determines whether to deploy the process Z on the platform side according to the following procedures (1) to (3).

(1) It is assumed that all the current processes X and Y under deployment of the current situation each issue the model request 20 that satisfies the TP requirement.

(2) It is assumed that a new process Z to be added this time is deployed, and the model request 20 is issued such that the process Z satisfies the TP requirement when the process Z operates alone.

(3) In the assumptions of (1) and (2), it is assumed that the task switching unit 55 performs scheduling by switching each task issued by each of the processes X, Y, and Z by the processing of FIGS. 5 to 7. In a case where the task switching unit 55 can plan scheduling that satisfies both the TP requirement and the TAT requirement of each of the processes X, Y, and Z even in consideration of the switching time of scheduling, the accommodation possibility calculation unit 51 determines that deployment is possible.

Hereinafter, the procedures (1) to (3) are formulated.

$$[ Math . 1 ]$$

$${}^{∀} i ∈ proc . \\ T\_tat [ i ] = {\sum }_{j \neq i} {n}_{j} T\_exec [ j ] + {\sum }_{cyc} T\_reconf [ k \to l ] \qquad ( Expression 3 )$$

$$∴ n [ i ] = \frac{1}{P\_total - 1} \cdot {\sum }_{j} ( \frac{T\_tat [ j ] - {\sum }_{cyc} T\_reconf [ k \to l ]}{T\_exec [ j ]} ) - \frac{T\_tat [ i ] - {\sum }_{cyc} T\_reconf [ k \to l ]}{T\_exec [ i ]} \qquad ( Expression 4 )$$

$${\sum }_{cyc} represents a cyclic sum . For example , when there are models 1 to 3 , \\ {\sum }_{cyc} T\_reconf [ k \to l ] = T\_reconf [ 1 \to 2 ] + T\_reconf [ 2 \to 3 ] + T\_reconf [ 3 \to 1 ]$$

At the maximum load, in the worst case from the TAT requirement, each process i needs to switch (the setting on the FPGA 70 of the model used by the task issued by) the process at most n[i] times of execution. n[i] at this time can be calculated by comparing the TAT requirement with the execution time+switching time of processes other than the own process as in (Expression 3) and (Expression 4).

$$[ Math . 2 ]$$

$${}^{∀} i ∈ proc . \\ {T}_{i} < \frac{{n}_{i}}{{\sum }_{cyc} T\_reconf [ j \to k ] + {\sum }_{j} {n}_{j} T\_exec [ j ]} \qquad ( Expression 5 )$$

$${T}_{i} \times ( T\_exec [ i ] + \frac{T\_tat [ i ]}{n [ i ]} ) < 1 \qquad ( Expression 6 )$$

At this time, a condition under which the TP requirement can be satisfied even in the worst case is expressed by (Expression 5). Then, (Expression 6) in which n[i] in (Expression 4) is substituted into (Expression 5) can be used as a discriminant of whether the accommodation possibility calculation unit 51 can be deployed.

Note that it is only required to use a sufficiently large T_tat[i] when the TAT requirement is not specified, and it is only required to use a sufficiently large R[i] when the TP requirement is not specified.

### Advantageous Effects

A scheduling device 100 of the present invention includes:
a controller unit 30 that acquires a model used by each task;
an FPGA control unit 50 that performs control to switch a setting of the FPGA 70 in such a manner that the model acquired by the controller unit 30 becomes processable; and
a scheduler unit 60 that refers to a queue 43 that stores a task for each model used by each task, reads a task using a model that has become processable by switching by the FPGA control unit 50, and causes the FPGA 70 to execute the task.

Thus, by supporting the switching control of the models on the FPGA 70 by the platform called the FPGA control unit 50, it is possible to execute tasks of a plurality of users while switching a plurality of types of models on the same accelerator (FPGA 70). Therefore, the FPGA 70 can be shared by multiple users, and the housing efficiency of the FPGA can be enhanced.

According to the present invention, the FPGA control unit 50 performs scheduling processing of switching the setting of the FPGA 70 in such a manner that the number of times of switching of the FPGA 70 is reduced by causing the FPGA 70 to continuously execute a plurality of tasks using the same model, and a waiting time from an arrival time of a task stored in the queue 43 is shortened.

Thus, it is possible to provide switching control that achieves both improvement in throughput and reduction in waiting time in a well-balanced manner for each best effort type task for which a concrete performance requirement is not specified.

A turn around time (TAT) requirement that is a time limit required from an arrival time of a task to an end time of the task is specified for each task of the present invention, and
the FPGA control unit 50 sets the switching from the current model A to the another model B in the FPGA 70 in a case where the end time of the another model B when it is assumed that the current model A is switched to the another model B on the basis of a switching time of the FPGA 70 from the current model A operating in the FPGA 70 to the another model B and an execution time of a task of the another model B exceeds a deadline time calculated from the TAT requirement of the another model B.

Thus, the switching control can be appropriately executed before the deadline is exceeded for each task of the deadline type for which the time limit is designated. That is, unlike the context switch of the CPU, the TAT requirement can be complied with even in the FPGA 70 in which the setting switching takes a considerable time.

Each process of the present invention issues one or more tasks,
a throughput (TP) requirement that defines a processing amount of a task per unit time is designated for each task, and
when a process Z newly occurs in addition to the processes X and Y being deployed, the FPGA control unit 50 determines that the process Z is deployable in a case where it is possible to plan scheduling processing that satisfies the TP requirements and the TAT requirements of the processes X and Y in addition to the TP requirements and the TAT requirements of the process Z can be prepared.

Thus, it is possible to prevent the capacity from exceeding due to the deployment in advance by estimating that the performance requirement cannot be satisfied by the deployment in advance for the process Z before the deployment by planning the scheduling processing.

### REFERENCE SIGNS LIST

10 Process
20 Model request
30 Controller unit
31 Command reception unit
32 Queue management unit
33 Used IP core control unit
34 FPGA model setting unit
40 Common unit
41 Controller cooperation unit
42 Queue distribution unit
43 Queue
50 FPGA control unit (control unit)
51 Accommodation possibility calculation unit
52 FPGA model management unit
53 FPGA model configuration unit
54 Task arrival time management unit
55 Task switching unit
56 Task execution time management unit
60 Scheduler unit
61 Inter-queue scheduling unit
62 In-queue scheduling unit
63 Controller cooperation unit
64 IP core mask setting unit
70 FPGA (accelerator)
71 IP core
100 Scheduling device

1. A scheduling device, comprising:
a controller unit, implemented using one or more processors, configured to acquire a model used by each task;
a control unit, implemented using the one or more processors, configured to perform control to switch a setting of an accelerator in such a manner that the model acquired by the controller unit becomes processable; and
a scheduler unit, implemented using the one or more processors, configured to refer to a queue that stores a task for each model used by each task, read a task using a model that has become processable by switching by the control unit, and cause the accelerator to execute the task.

2. The scheduling device according to claim 1, wherein
the control unit is configured to perform scheduling processing of switching the setting of the accelerator in such a manner that a number of times of switching of the accelerator is reduced by causing the accelerator to continuously execute a plurality of tasks using the same model, and a waiting time from an arrival time of a task stored in the queue is shortened.

3. The scheduling device according to claim 1, wherein
a turn around time (TAT) requirement that is a time limit required from an arrival time of a task to an end time of the task is specified for each task, and
the control unit is configured to set switching from a current model to another model in the accelerator in a case where an end time of the another model when the current model is switched to the another model on a basis of a switching time of the accelerator from the current model operating in the accelerator to the another model and an execution time of a task of the another model exceeds a deadline time calculated from the TAT requirement of the another model.

4. The scheduling device according to claim 3, wherein
each process is configured to issue one or more tasks,
a throughput (TP) requirement that defines a processing amount of a task per unit time is designated for each task, and
when a new process is configured to occur in addition to a current process being deployed, the control unit is configured to determine that the new process is deployable based on scheduling processing being configured to satisfy the TP requirement and the TAT requirement of the current process in addition to the TP requirement and the TAT requirement of the new process.

5. A scheduling method for a scheduling device including a controller unit implemented using one or more processors, a control unit implemented using the one or more processors, and a scheduler unit implemented using the one or more processors, the scheduling method comprising:
by the controller unit, acquiring a model used by each task;
by the control unit, performing control to switch a setting of an accelerator in such a manner that the model acquired by the controller unit becomes processable; and
by the scheduler, referring to a queue that stores a task for each model used by each task, reading a task using a model that has become processable by switching by the control unit, and causing the accelerator to execute the task.

6. A non-transitory computer readable medium storing a program, wherein execution of the program causes a computer to function as the scheduling device according to claim 1.
